(19) United States
(12) Patent Application Publication
(10) Pub. No.: US 2012/0169108 A1
(43) Pub. Date: Jul. 5, 2012

(54) CANTILEVERED SEAT SUPPORT

(75) Inventor: Michael Kammler, Kempen (DE)

(73) Assignee: Siemens Aktiengesellschaft, Muenchen (DE)

(21) Appl. No.: 13/395,170

(22) PCT Filed: Aug. 16, 2010
(86) PCT No.: PCT/EP2010/061904

§ 371 Date: Mar. 9, 2012

(30) Foreign Application Priority Data
Sep. 9, 2009 (DE) 10 2009 040 779.0

(51) Int. Cl. B60N 2/015

(52) U.S. Cl. 297/452.39

(57) ABSTRACT

A cantilevered seat support for a vehicle has only connections to a sidewall of the vehicle. The cantilever seat support predominantly consists of components that are produced by deep drawing. The seat support has a reduced weight and at the same time is intended to be able to be produced from low cost parts.

The invention relates to a cantilevered seat support for a vehicle, said seat support being connected only to a side wall of the vehicle. A cantilevered seat connection is distinguished by typically two connections of the seat support to a side wall of a vehicle being established. By contrast, conventional seat connections have at least one seat connection to the floor.

The cantilevered seat support is used ever more frequently particularly in buses and rail vehicles, since the principle of said seat support makes it easier to clean the vehicle. This is because the elimination of seat connections to the floor considerably facilitates the cleaning of the floor surface of the vehicle and also accelerates the cleaning.

A seat support typically serves to realize two passenger seats which are arranged next to each other in the longitudinal direction of the seat support. For this purpose, two suitably shaped seat shells are fitted on a supporting structure of the seat support. It should be noted with regard to the cantilevered seat support structure making cleaning easy that a necessary height for the cleaning of the floor should be left free under a wall-mounted vehicle seat too. This has the consequence of not enabling a rectilinear connection to be provided between a lower coupling point of the seat support to the side wall and the seat surface of the inner passenger seat. On the contrary, a lower side of a supporting structure of the seat support has to have a curved contour, specifically such that, with strength requirements for the seat support being taken into consideration, the free height below the supporting structure is at the maximum possible for every distance to the side wall. A further advantage of the cantilevered seat support is that the latter permits flexible positioning of the rows of seats in the longitudinal direction of the vehicle and also a simple and acoustically effective vehicle floor.

However, conventional cantilevered seat supports are significantly heavier and more expensive than seat supports with conventional seat connections in the floor. Previously known approaches to reducing the weight result in additional costs while all of the approaches to reducing the piece costs involve additional weight.

Cantilevered seat supports are conventionally designed as welded structures from angled sheet metal or profiles. With these means of implementation, the requirements for high flexural rigidity, i.e. little lowering of the seat in the vertical direction under loading, torsional rigidity, i.e. little deflection of the seat back in the longitudinal direction of the vehicle under loading, energy absorption capability, i.e. controlled deformation in the event of a crash, primarily in the longitudinal direction, and favorable one-off costs, with plates and standard profiles being used as the semi-finished products, are satisfactorily met.

The problem already discussed above of cantilevered seat supports in respect of weight and piece costs in comparison to those supports having conventional floor connections is complicated further by the lower side of the supporting structure requiring a curved contour for favorable cleaning of the floor. For this reason, it is difficult to realize the cantilevered seat support with few and simple parts and joining points using angled sheet metal or profiles.

Proceeding therefrom, the invention is based on the object of improving the seat support described at the beginning in such a manner that said seat support has a reduced weight, wherein said seat support at the same time is intended to be able to be produced in a method permitting low piece costs.

This object is achieved in the case of the known cantilevered seat support in that said seat support predominantly consists of components which are produced by deep drawing. The use of deep drawn parts makes it possible in particular to produce the curved contour of the lower side of the supporting structure of the seat support, which contour is required for the favorable cleaning of the floor, at low piece costs. In addition, this technology permits a stress-appropriate variation of the cross section of the seat support for optimized flexural and torsional rigidity and buckling resistance, and the impressing of buckling stiffeners.

Although higher one-off costs arise for the seat support which is predominantly produced from a deep drawn component in comparison to a means of implementation from angled sheet metal or profiles, this is only of minor significance in the piece numbers typical for seat supports.

The seat support preferably consists of at most five components, and therefore the outlay for connecting the components to one another by means of suitable fastening means or joining methods is smaller.

The seat support preferably consists of two components which are produced by deep drawing and are then to be joined to each other.

In this case, a first component of the seat support can be formed by a holding plate for bearing against a side wall of the vehicle, and a second component can be formed by a carrying structure to be welded to the holding plate, the holding plate and the carrying structure being welded to each other in the circumferential direction of that edge of the carrying structure which faces the holding plate, and therefore a weld seam lies in a plane defined by the holding plate. In this case, the holding plate is in the form of sheet metal while the carrying structure with a curved contour on the lower side thereof is produced by deep drawing.

As an alternative, the two components can also be present in such a manner that the seat support is divided by the central longitudinal plane thereof into two deep drawn components and the latter are welded to each other.

In a further embodiment, it is possible for the seat support to be divided by a horizontal plane into the two components and for the latter to be welded to each other. In a development of this embodiment, the horizontal plane can be arranged above upper coupling points of the seat support for a side wall of the vehicle.

Sheet metal material is typically used for the production of the seat support, in particular material consisting of high-strength steel.

A laser welding method is preferably used to join the individual components of the seat support. However, other fastening or joining methods are possible.

Exemplary embodiments of the invention are explained in more detail below with reference to the further description. In the figures:

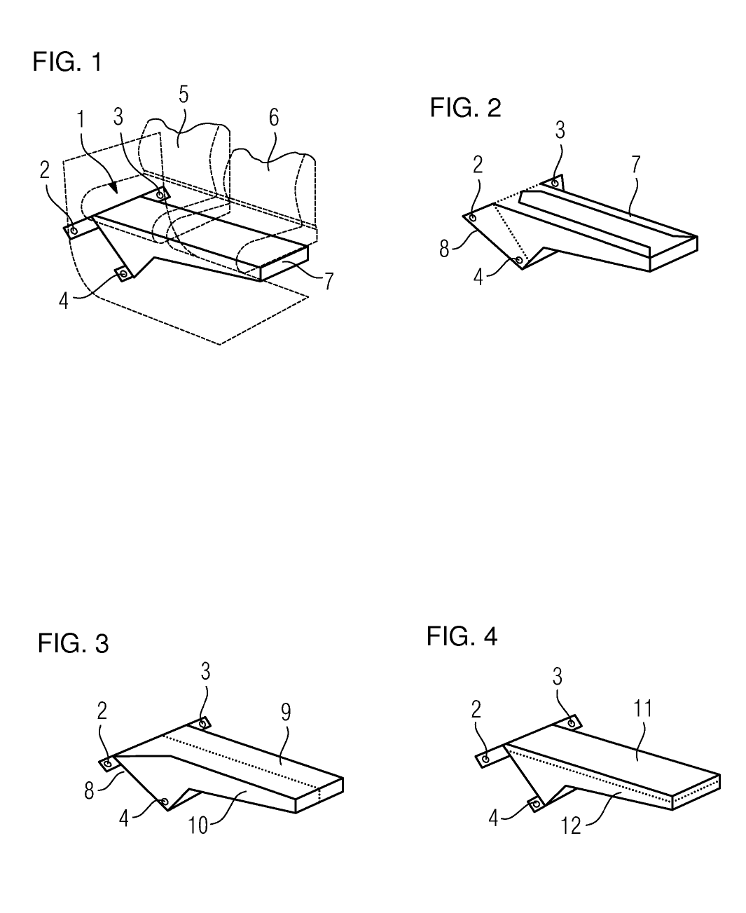

FIG. 1 shows a perspective view of a cantilevered seat support,

FIG. 2 shows a perspective view of a first embodiment of a cantilevered seat support consisting of two components,

FIG. 3 shows a perspective view of a second embodiment of a cantilevered seat support consisting of two components, and

FIG. 4 shows a perspective view of a third embodiment of a cantilevered seat support consisting of two components.

FIG. 1 shows the known external form of a cantilevered seat support 1, which form is produced in the prior art, for example, from angled sheet metal. However, in the present cantilevered seat support 1, components produced by deep drawing are predominantly used. Possible weld seams are not illustrated in FIG. 1.

The cantilevered seat support 1 is to be fastened to a side wall (reproduced by dashed lines) of a rail vehicle via two upper fastening points 2, 3 and two lower fastening points 3 (the fourth fastening point is not illustrated in the figure). Passenger seats 5, 6 which are fitted onto the cantilevered seat support 1 are likewise illustrated by dashed lines.

A lower side of a carrying structure 7 of the seat support 1 is of curved design, thus producing a substantial clearance above the floor, which ensures the favorable cleaning properties of the vehicle. Whereas the upper side of the carrying structure 7 runs horizontally, the lower side of the carrying structure 7 extends obliquely in the direction of the side wall from the inside outward initially at a relatively small angle. At a predetermined distance from the side wall, the lower side bends downward and ends in the region of the lower fastening points 4.

In the exemplary embodiment of FIG. 1, the fastening points 2, 3, 4 are each provided at ends of associated tabs which extend in the longitudinal direction of the rail vehicle either at the upper or at the lower end of the seat support 1.

According to the exemplary embodiments of FIGS. 2 to 4, the seat support 1 is in each case constructed from two main components which are joined to each other with the aid of laser welding. At least one main component is produced in each case by deep drawing. In the exemplary embodiment of FIG. 2, the two main components are formed by the carrying structure 7 and a holding plate 8, wherein the latter has the fastening points 2, 3, 4. The carrying structure 7 is fastened to the holding plate 8 in the plane of the holding plate 8 by laser welding. In this exemplary embodiment, a separating plane between the two main components runs in the longitudinal direction of the rail vehicle.

In the exemplary embodiment according to FIG. 3, the two main components of the seat support 1 are divided by a central longitudinal plane of the seat support 1 into two halves which, in turn, are welded to each other by laser welding. The two halves 9, 10 each have an upper and a lower fastening point and are produced by deep drawing.

FIG. 4 shows an exemplary embodiment in which the seat support 1 is divided by a horizontal plane into two main components which run above the upper fastening points 2, 3 of the seat support 1. The two main components of the seat support 1 are now formed by sheet metal 11, which forms the upper side of the seat support 1, and a lower structure 12.

A common feature of all of the exemplary embodiments is that all of the exemplary embodiments, with reference to the volume of the seat support 1, predominantly consist of deep drawn components. In the illustrations according to FIGS. 2 to 4, particularly favorable profiles of the laser weld seams are possible.

At the piece numbers typical for seat supports, the higher one-off costs to be expected through the use of deep drawn parts play only an insignificant role in comparison to a means of implementation from angled sheet metal or profiles. A considerable lightweight construction potential can be obtained by the use of high-strength steel sheets. In order to reduce the piece costs for producing the seat support 1, the use of an automated laser welding process for the few weld seams is considered to be expedient, wherein the use of laser welding technology itself also opens up a further lightweight construction potential.

1-10. (canceled)

11. A cantilevered seat support for a vehicle, the cantilevered seat support being connected only to a side wall of the vehicle, the cantilevered seat support comprising:
components produced by deep drawing.

12. The cantilevered seat support according to claim 11, wherein said components consist of at most five components.

13. The cantilevered seat support according to claim 12, wherein said components are two components.

14. The cantilevered seat support according to claim 13, wherein said components include a first component being a holding plate for bearing against the side wall of the vehicle, and a second component being a carrying structure welded to said holding plate, said holding plate and said carrying structure welded to each other in a circumferential direction of that edge of said carrying structure which faces said holding plate, and therefore a weld seam lies in a plane defined by said holding plate.

15. The cantilevered seat support according to claim 13, wherein the cantilevered seat support is divided by a central longitudinal plane thereof into said two components and said two components are welded to each other.

16. The cantilevered seat support according to claim 13, wherein the cantilevered seat support is divided by a horizontal plane into said two components and said two components are welded to each other.

17. The cantilevered seat support according to claim 16, wherein said horizontal plane is disposed above upper coupling points for the side wall of the vehicle.

18. The cantilevered seat support according to claim 11, wherein said components are formed from a sheet metal material.

19. The cantilevered seat support according to claim 18, wherein said sheet metal material consists of high-strength steel.

20. The cantilevered seat support according to claim 11, wherein said components are at least partially connected to one another by laser welding.
